(19) United States
(12) Patent Application Publication
(10) Pub. No.: US 2025/0256782 A1
(43) Pub. Date: Aug. 14, 2025

(54) FRONT SIDE STRUCTURE OF CARGO BOX OF VEHICLE

(71) Applicants: Hyundai Motor Company, Seoul (KR); Kia Corporation, Seoul (KR)

(72) Inventor: Jun-Young PARK, Hwaseong-si (KR)

(73) Assignees: Hyundai Motor Company, Seoul (KR); Kia Corporation, Seoul (KR)

(21) Appl. No.: 18/823,330

(22) Filed: Sep. 3, 2024

(30) Foreign Application Priority Data
Feb. 13, 2024 (KR) 10-2024-0020493

(51) Int. Cl. B62D 33/02

(52) U.S. Cl. CPC B62D 33/02

(57) ABSTRACT

A front side structure of a cargo box of a vehicle including a cabin where occupants board includes a side external panel provided on an external side of the cargo box to form an exterior of the cargo box, a side internal panel provided on an internal side of the side external panel, a front guard mounted at an upper end portion of a front portion of the cargo box, and a front side member mounted at a front end portion of the cargo box, wherein a side end portion of the front side member and a side end portion of the front guard are fastened together at the front end portion of the cargo box, and a lower end portion of the front side member is fastened to an end portion of a first floor member.

### CROSS-REFERENCE(S) TO RELATED APPLICATIONS

The present application claims priority to Korean Patent Application No. 10-2024-0020493, filed on Feb. 13, 2024, the entire contents of which is incorporated herein for all purposes by this reference.

### BACKGROUND OF THE PRESENT DISCLOSURE

### Field of the Present Disclosure

The present disclosure relates to a front side structure of a cargo box of a vehicle, which improves rigidity of a front portion of the cargo box of the vehicle.

### Description of Related Art

In a vehicle such as a pickup truck, a cabin for accommodating occupants is formed at a front side of the vehicle, and a cargo box for loading or unloading a cargo is formed at a rear side of the vehicle.

In a frame body-type pickup truck, a cabin 12 and a cargo box 13 are disposed on an upper portion of a frame 11 which extends in a longitudinal direction of the vehicle 1 (see FIG. 1).

The cargo box 13 is provided with a plurality of structural members between an external panel 13a and an internal panel and connects these members to provide rigidity to the cargo box 13.

However, in the cargo box 13 of the vehicle 1 according to the related art, portions where the members are not connected to each other are present, and there is a problem in that the rigidity is degraded in these portions.

For example, the members are not connected to each other at a portion where a side portion and a front portion of the cargo box 13 meet, and thus when a load is applied to such the portion where the side portion and the front portion of the cargo box 13 meet due to a collision or the like, there is a problem in that an upper end portion of the side portion of the cargo box 13 may be damaged.

### BRIEF SUMMARY

Various aspects of the present disclosure are directed to providing a front side structure of a cargo box of a vehicle, which improves rigidity of a portion where a side portion and a front portion meet in the cargo box of the vehicle.

Other objects and advantages of the present disclosure may be understood by the following description and become apparent with reference to the exemplary embodiments of the present disclosure. Also, it is obvious to those skilled in the art to which the present disclosure pertains that the objects and advantages of the present disclosure may be realized by the means as claimed and combinations thereof.

In accordance with an exemplary embodiment of the present disclosure, there is provided a front side structure of a cargo box of a vehicle including a cabin where occupants board, which includes a side external panel provided on an external side of the cargo box to form an exterior of the cargo box provided at a rear side of the cabin, a side internal panel provided on an internal side of the side external panel in the cargo box, a front guard mounted at an upper end portion of a front portion of the cargo box in a width direction of the vehicle, and a front side member mounted at a front end portion of the cargo box, wherein a side end portion of the front side member and a side end portion of the front guard may be fastened together at the front end portion of the cargo box, and a lower end portion of the front side member may be fastened to an end portion of a first floor member disposed at a lower end portion of the front portion of the cargo box.

The front side structure may further include a side upper member disposed at an upper end portion of the side external panel or an upper end portion of the side internal panel in a longitudinal direction of the vehicle, the side upper member may be formed so that a lower portion thereof is open and an upper portion thereof and both side portions thereof may be each formed to include a cross section bent at a right angle, and the front side member may be fastened to an internal portion of the side upper member.

The upper end portion of the side internal panel may be positioned between the side upper member and the front side member.

A flange may be formed along a circumference of the front side member, and the flange may be fastened to the side upper member and the front guard.

The side end portion of the front guard may be bent toward a front side of the vehicle, and the bent portion may be fastened to the side upper member and the front side member.

An upper end portion of the front side member may be formed to be convex toward an external side of the cargo box, and a lower portion thereof may be formed to be convex toward an internal side of the cargo box.

The first floor member may be fastened to a frame of the vehicle.

A frame mount may be formed to protrude from the frame, and the frame mount may be fastened to a bottom portion of the first floor member.

The first floor member may be fastened to the front side member above a portion fastened to the frame.

In accordance with another exemplary embodiment of the present disclosure, there is provided a front side structure of a cargo box of a vehicle including a cabin where occupants board, which includes a side external panel provided on an external side of the cargo box to form an exterior of the cargo box provided at a rear side of the cabin, a side internal panel provided on an internal side of the side external panel in the cargo box, a side upper member disposed at an upper end portion of the side external panel or an upper end portion of the side internal panel in a longitudinal direction of the vehicle, a front guard mounted at an upper end portion of a front portion of the cargo box in a width direction of the vehicle, and a front side member mounted at a front end portion of the cargo box, wherein a front end portion of the side upper member, a side end portion of the front side member, and a side end portion of the front guard may be fastened together on the front end portion of the cargo box.

The side upper member may be formed so that the lower portion is open and the upper portion and both side portions may be each formed to include a cross section bent at a right angle, and the front side member may be fastened to an internal portion of the side upper member.

The upper end portion of the side internal panel may be positioned between the side upper member and the front side member.

A flange may be formed along a circumference of the front side member, and the flange may be fastened to the side upper member and the front guard.

The side end portion of the front guard may be bent toward a front side of the vehicle, and the bent portion may be fastened to the side upper member and the front side member.

A lower end portion of the front side member may be fastened to an end portion of a first floor member disposed at a lower end portion of the front portion.

An upper end portion of the front side member may be formed to be convex toward an external side of the cargo box, and a lower portion thereof may be formed to be convex toward an internal side of the cargo box.

The first floor member may be fastened to a frame of the vehicle.

A frame mount may be formed to protrude from the frame, and the frame mount may be fastened to a bottom portion of the first floor member.

The first floor member may be fastened to the front side member above a portion fastened to the frame.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a side view exemplarily illustrating a typical frame-body type pickup truck in the related art.

FIG. 2 is a perspective view exemplarily illustrating a cargo box of a vehicle to which a front side structure of a cargo box according to an exemplary embodiment of the present disclosure is applied.

FIG. 3 is a perspective view showing an internal side of a portion where a side portion and a front portion of a cargo box are joined to which a front side structure of a cargo box according to an exemplary embodiment of the present disclosure is applied.

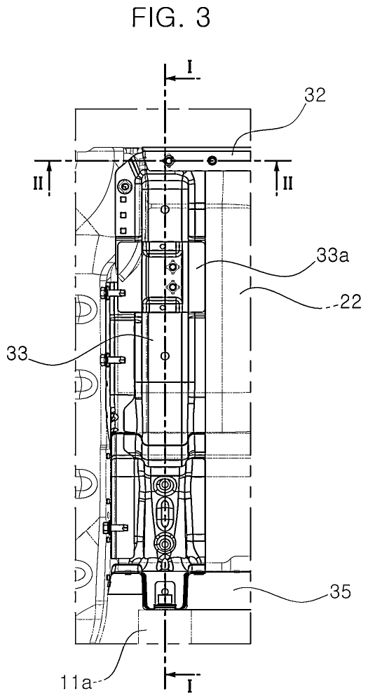

FIG. 4 is a cross-sectional view taken along line I-I of FIG. 3.

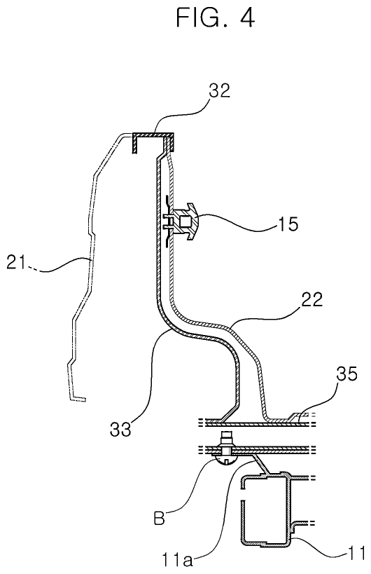

FIG. 5 is a cross-sectional view taken along line II-II of FIG. 3.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a front side structure of a cargo box of a vehicle according to an exemplary embodiment of the present disclosure will be described in detail with reference to the accompanying drawings.

The front side structure of a cargo box of a vehicle according to an exemplary embodiment of the present disclosure includes a side external panel 21 provided on an external side of a cargo box 13 to form an exterior of the cargo box 13 provided at a rear side of a cabin 12 where occupants board in a vehicle 1, a side internal panel 22 provided inside the side external panel 21 in the cargo box 13, a front guard 31 disposed at an upper end portion of a front portion of the cargo box 13 in a width direction of the vehicle 1, and a front side member 33 disposed at a front end portion of a side portion of the cargo box 13, wherein a side end portion of the front side member 33 and a side end portion of the front guard 31 may be fastened together to a front end portion of the cargo box 13, and a lower end portion of the front side member 33 may be fastened to an end portion of a first floor member 35 disposed at a lower end portion of the front portion of the cargo box 13.

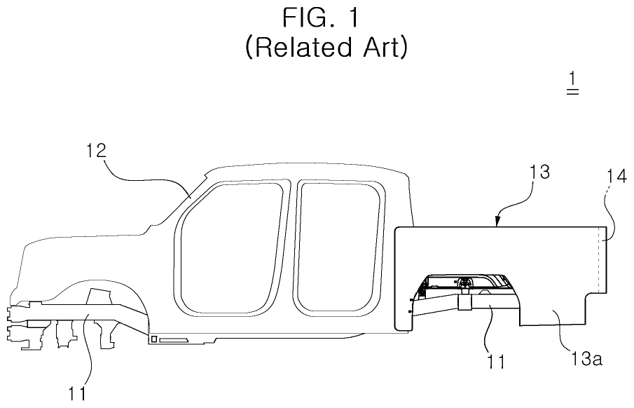

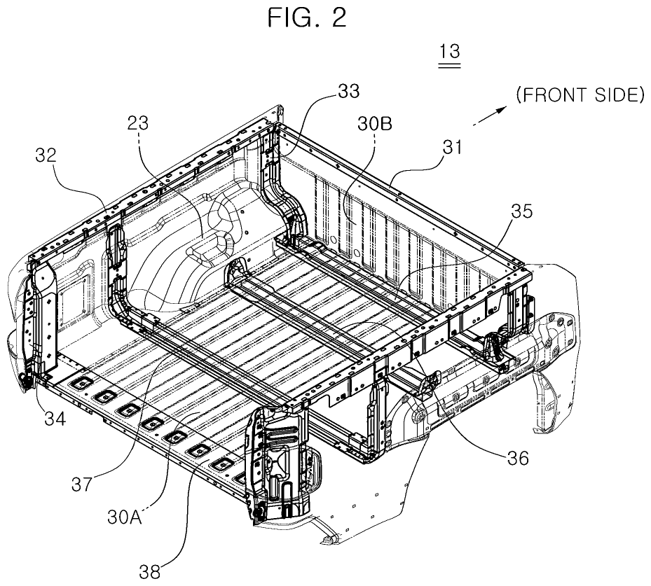

FIG. 2 shows a side structure of a cargo box 13 of a vehicle 1 according to an exemplary embodiment of the present disclosure. Referring back to FIG. 1, in the vehicle 1 such as a pickup truck, the cabin 12 where occupants board is provided on an upper portion of a frame 11 which extends in a longitudinal direction of the vehicle 1, and the cargo box 13 for loading or unloading a cargo may be provided at a rear side of the cabin 12.

The side structure of a cargo box of a vehicle according to an exemplary embodiment of the present disclosure may be applied to the cargo box 13 of a small truck such as a pickup truck.

A side portion of the cargo box 13 may be formed using the side external panel 21 and the side internal panel 22.

The side external panel 21 may be provided on an external side of the cargo box 13 to form an exterior of the cargo box 13.

The side internal panel 22 may be provided inside the side external panel 21.

The side external panel 21 and the side internal panel 22 may be disposed at intervals from each other, and upper end portions of the side external panel 21 and the side internal panel 22 may be fastened to each other.

Here, referring to FIG. 2, a floor panel 30A on which the cargo is loaded and which forms a floor of the cargo box 13, a front panel 30B for closing a front end portion of the cargo box 13, and a tailgate 14 provided at a rear end portion of the cargo box 13 to be openable or closable, and thus a basic form of the cargo box 13 may be formed.

Furthermore, members which may reinforce a rigidity of the cargo box 13 may be additionally applied, and thus the rigidity of the cargo box 13 may be improved. A metal plate may be bent in a direction perpendicular to a longitudinal direction or a closed cross-section structure may be formed so that a rigidity of an individual member, which is applied to rigidity reinforcement, may be increased, and then the rigidity reinforced member may be applied to reinforce the rigidity of the cargo box 13.

Meanwhile, hereinafter, two members being fastened means that the two members may be fastened to each other using welding (W) or bolts (B).

In an exemplary embodiment of the present disclosure, a rigidity of a front side portion of the cargo box 13, that is, a portion where front end portions of the side external panel 21 and the side internal panel 22 and the front panel of the cargo box 13 may be brought into contact with each other in the cargo box 13, may be improved.

First, a side upper member 32 may be provided at an upper end portion of the cargo box 13 in a longitudinal direction of the vehicle 1. The side upper member 32 may be formed to include an open lower portion and include an upper portion and both sides with a cross-section bent at a right angle, so that the side upper member 32 may support the upper end portion of the cargo box 13.

A front side member 33 may be disposed at the front end portion of the side portion of the cargo box 13.

The front side member 33 may be disposed between the side external panel 21 and the side internal panel 22 at the front end portion of the side portion of the cargo box 13. The front side member 33 may be formed substantially in a height direction of the vehicle 1, and an upper portion thereof becomes convex to the external side of the cargo box 13, and a lower portion thereof becomes convex to the internal side of the cargo box 13 due to a wheel house 23. Thus, the front side member 33 may be formed in a shape in which a convex directions at the upper portion and the lower portions may be reversed. The front side member 33 may be disposed to surround the side internal panel 22.

An upper end portion of the front side member 33 may be fastened to the side upper member 32. In the instant case, in the side upper member 32, the front side member 33 may be fastened to an internal portion of the cargo box 13, and an upper end portion of the side internal panel 22 may be positioned between the side upper member 32 and the front side member 33.

Thus, an upper end portion of the front portion of the cargo box 13 may include a sturdy and solid structure.

The front side member 33 may be fastened to an end portion of the first floor member 35 whose lower end portion is disposed at a lower end portion of the front portion of the cargo box 13. The front side member 33 and the first floor member 35 may form a ‘U’-shaped structure, and the upper end portion of the front side member 33 may be fastened to a front end portion of the side upper member 32 so that the front end portion of the side upper member 32 has solid structure.

The first floor member 35 may be fastened to the frame 11 of the vehicle 1. A frame mount 11a may be formed to protrude from the frame 11, and the frame mount 11a may be fastened to a bottom portion of the first floor member 35 so that the first floor member 35 may be fastened to the frame 11.

The first floor member 35 may be fastened to the front side member 33 above a portion fastened to the frame 11. Because the first floor member 35 includes an inverted shape, a distance between a portion where the first floor member 35 is mounted on the frame 11 and a portion where the first floor member 35 is mounted on the front side member 33 may be minimized so that a sturdy structure may be implemented.

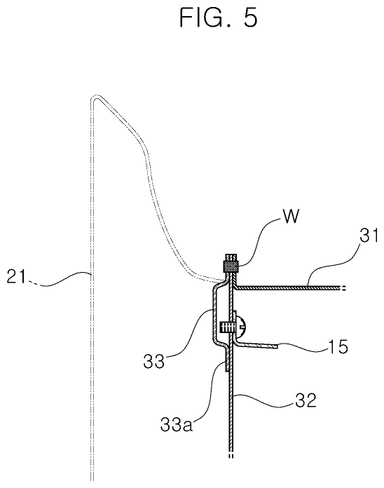

The front end portion of the side upper member 32 may also be fastened to a side end portion of the front guard 31 disposed on an upper portion of the front end portion of the cargo box 13 in the width direction of the vehicle 1. Meanwhile, because the front end portion of the side upper member 32 is also fastened to the upper end portion of the front side member 33, the front end portion of the side upper member 32, the side end portion of the front side member 33, and the side end portion of the front guard 31 may be fastened together on the front end portion of the cargo box 13 (see FIG. 5).

Because a flange 33a is formed along a circumference of the front side member 33, the front side member 33 may be fastened to the side upper member 32 and the front guard 31 through the flange 33a. In the instant case, a hook 15 fastened to the side upper member 32 may not be fastened to the front guard 31 and may be fastened only to the side upper member 32 (see FIG. 5).

Meanwhile, the side end portion of the front guard 31 may be bent toward the front side of vehicle 1, and the bent portion may be fastened to the side upper member 32 and the front side member 33.

In the cargo box 13, a second floor member 36, a third floor member 37, and a fourth floor member 38 may be provided to be disposed in the width direction of the vehicle 1 from the first floor member 35 toward the rear side of the vehicle 1 or to extend upward in a state of being disposed in the width direction of the vehicle 1.

Both end portions of the second floor member 36 may be fastened to a wheel house 23.

The third floor member 37 may be formed to extend in the width direction of the vehicle 1 at a rear side of the second floor member 36 and then extend upwards. An end portion of the third floor member 37 may be fastened to the side upper member 32, so that the third floor member 37 supports the side upper member 32 in the middle portion of the cargo box 13.

The fourth floor member 38 may be disposed in the width direction of vehicle 1 at the rear end portion of the cargo box 13 and may be fastened to a lower end portion of a D-post 34 supporting the tailgate 14 at the rear end portion of the cargo box 13.

In accordance with a front side structure of a cargo box of a vehicle, by fastening a floor member and a front guard to a portion where a side portion and a front side of the cargo box of the vehicle meet, a rigidity of the portion where a side portion and a front side of the cargo box meet may be improved.

Therefore, even when a load is applied to a portion where a side portion and a front side of the cargo box meet due to a collision or the like, it is possible to prevent or minimize deformation of an upper portion of the cargo box.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A front side structure of a cargo box of a vehicle including a cabin where occupants board, the front side structure comprising:
a side external panel provided on an external side of the cargo box to form an exterior of the cargo box provided at a rear side of the cabin;
a side internal panel provided on an internal side of the side external panel in the cargo box;
a front guard mounted at an upper end portion of a front portion of the cargo box in a width direction of the vehicle; and
a front side member mounted at a front end portion of the cargo box,
wherein a side end portion of the front side member and a side end portion of the front guard are fastened together at the front end portion of the cargo box, and
wherein a lower end portion of the front side member is fastened to an end portion of a first floor member disposed at a lower end portion of the front portion of the cargo box.

2. The front side structure of claim 1, further including:
a side upper member disposed at an upper end portion of the side external panel or an upper end portion of the side internal panel in a longitudinal direction of the vehicle,
wherein the side upper member includes a lower portion, which is open, an upper portion, and first and second side portions to include a cross section bent at a right angle, and
wherein the front side member is fastened to an internal portion of the side upper member.

3. The front side structure of claim 2, wherein the upper end portion of the side internal panel is mounted between the side upper member and the front side member.

4. The front side structure of claim 2, wherein a flange is formed along a circumference of the front side member, and the flange is fastened to the side upper member and the front guard.

5. The front side structure of claim 2, wherein the side end portion of the front guard is bent toward a front side of the vehicle, and the bent side end portion is fastened to the side upper member and the front side member.

6. The front side structure of claim 1, wherein an upper end portion of the front side member is formed to be convex toward the external side of the cargo box, and a lower portion of the front side member is formed to be convex toward the internal side of the cargo box.

7. The front side structure of claim 1, wherein the first floor member is fastened to a frame of the vehicle.

8. The front side structure of claim 7, wherein a frame mount is formed to protrude from the frame, and the frame mount is fastened to a bottom portion of the first floor member.

9. The front side structure of claim 7, wherein the first floor member is fastened to the front side member above a portion fastened to the frame.

10. A front side structure of a cargo box of a vehicle, the front side structure comprising:
a side external panel provided on an external side of the cargo box to form an exterior of the cargo box provided at a rear side of a cabin where occupants board in the vehicle;
a side internal panel provided on an internal side of the side external panel in the cargo box;
a side upper member disposed at an upper end portion of the side external panel or an upper end portion of the side internal panel in a longitudinal direction of the vehicle;
a front guard mounted at an upper end portion of a front portion of the cargo box in a width direction of the vehicle; and
a front side member mounted at a front end portion of the cargo box,
wherein a front end portion of the side upper member, a side end portion of the front side member, and a side end portion of the front guard are fastened together on the front end portion of the cargo box.

11. The front side structure of claim 10,
wherein the side upper member includes a lower portion, which is open, an upper portion, and first and second side portions to include a cross section bent at a right angle, and
wherein the front side member is fastened to an internal portion of the side upper member.

12. The front side structure of claim 11, wherein the upper end portion of the side internal panel is mounted between the side upper member and the front side member.

13. The front side structure of claim 10, wherein a flange is formed along a circumference of the front side member, and the flange is fastened to the side upper member and the front guard.

14. The front side structure of claim 10, wherein the side end portion of the front guard is bent toward a front side of the vehicle, and the bent side end portion is fastened to the side upper member and the front side member.

15. The front side structure of claim 10, wherein a lower end portion of the front side member is fastened to an end portion of a first floor member disposed at a lower end portion of the front portion of the cargo box.

16. The front side structure of claim 15, wherein an upper end portion of the front side member is formed to be convex toward the external side of the cargo box, and a lower portion of the front side member is formed to be convex toward the internal side of the cargo box.

17. The front side structure of claim 15, wherein the first floor member is fastened to a frame of the vehicle.

18. The front side structure of claim 17, wherein a frame mount is formed to protrude from the frame, and the frame mount is fastened to a bottom portion of the first floor member.

19. The front side structure of claim 17, wherein the first floor member is fastened to the front side member above a portion fastened to the frame.
